(19) United States
(12) Patent Application Publication
(10) Pub. No.: US 2008/0151947 A1
(43) Pub. Date: Jun. 26, 2008

(54) Periodically-chipred holographic volume transmission gratings

(76) Inventors: James Harrison, Oro Valley, AZ (US); Jacy Richard Titus, San Jose, CA (US)

Correspondence Address: Brian F. Swienton;Newport Corporation, 1791 Deere Avenue, Irvine, CA, 92606, US

(21) Appl. No.: 11/643,108

(22) Filed: Dec. 20, 2006

(51) Int. Cl. H01S 3/10; G02B 5/32

(52) U.S. Cl. 372/20; 372/102; 359/15

(57) ABSTRACT

The present application discloses a laser device and includes at least one laser system having at least one two emitters therein, each emitter configured to output a laser output having a first wavelength spectrum, at least one grating device having at least two grating regions formed thereon, each grating region configured to receive the laser output from one of the emitters and provide an optical feedback signal thereto, each grating region configured to output an output signal having at least a second wavelength spectrum.

### BACKGROUND

Presently, diode lasers are used in a variety of applications. While their widespread acceptance within a variety of laser applications is acknowledged, a number of shortcomings have been identified. For example, precise control of the output wavelengths emitted from individual diode laser devices as well as diode laser arrays has proven problematic. More specifically, the peak wavelength emitted from diode lasers may change in response to thermal variations in the device or surrounding environment. As such, a single emitter or emitters forming a diode array may not consistently output a desired wavelength.

In response thereto, a number of approaches have been developed to stabilize the output of one or more diode lasers. For example, thermal isolators may be positioned in contact with or in close proximity to the diode lasers, thereby maintaining the operating temperature of the diode lasers at a pre-determine temperature. As a result, thermal variations of the diode laser may be reduced, thereby stabilizing the output wavelength thereof. While this approach has proven successful in the past, a number of shortcomings have been identified. For example, the thermal isolators occupy space within a diode laser device, thereby enlarging the overall size of the diode laser device. Further, the power consumption of the thermal isolators must be accounted for.

Thus, in light of the foregoing, there is an ongoing need for a device and method maintaining the output wavelength of one or more diode lasers at a desired wavelength.

### SUMMARY

Various embodiments of periodically-chirped holographic volume transmission gratings are disclosed herein. In one embodiment, the present application discloses a laser device and includes at least one laser system having at least two emitters therein, each emitter configured to output a laser output having a first wavelength spectrum, at least one grating device having at least two grating regions formed thereon, each grating region configured to receive the laser output from one of the emitters and provide an optical feedback signal thereto, each grating region configured to output an output signal having at least a second wavelength spectrum.

In another embodiment, the present application is directed to a periodically-chirped holographic volume transmission grating and includes a device body having multiple grating regions formed thereon, each grating region separated from adjoining grating regions by a distance P2 and configured to receive a laser signal from and provide optical feedback to a single laser emitter included within a multiple emitter laser device, each grating region configured to output an output signal have a at least one output wavelength spectrum.

The present application further discloses a method of narrowing the wavelength spectrum of an output of a laser system and includes forming multiple grating regions on a grating device, each grating region separated by a distance substantially equal to the distance individual emitters of a laser system, each grating region configured to narrow a wavelength spectrum of each laser signal received from each emitter, and adjusting the position of the grating device relative to the laser system to alter the wavelength spectrum of an output of the grating device.

In another embodiment, the present application is directed to a method of manufacturing a periodically-chirped holographic volume transmission grating and includes providing a grating body, and holographically forming multiple grating regions on the grating body, each grating region separated from adjoining grating region by a distance of about 0.5 mm to about 2.5 mm.

Other features and advantages of the embodiments of periodically-chirped holographic volume transmission gratings as disclosed herein will become apparent from a consideration of the following detailed description.

### BRIEF DESCRIPTION OF THE DRAWINGS

Various embodiments of periodically-chirped holographic volume transmission gratings will be explained in more detail by way of the accompanying drawings, wherein:

FIG. 1 shows a schematic diagram of a laser system having multiple emitters in optical communication with multiple grating regions formed on a grating device;

FIG. 2 shows a schematic diagram of an emitter of a laser system outputting a signal having a first wavelength spectrum to a grating region formed on an embodiment of a grating device configured to output a signal having a second wavelength spectrum;

FIG. 3 shows a schematic diagram of an embodiment of a grating device having multiple grating regions formed thereon, each grating region is configured to output substantially the same wavelength spectrum; and

FIG. 4 shows a schematic diagram of an embodiment of a grating device having multiple grating regions formed thereon, at least one of the grating regions is configured to output a different wavelength spectrum from other grating regions formed on the grating device.

### DETAILED DESCRIPTION

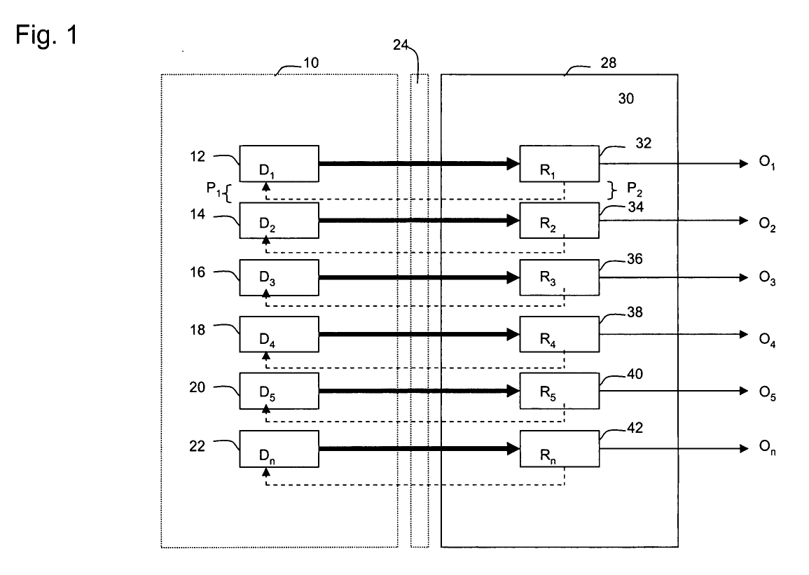

The present application is directed to a device and architecture configured to ensure that the output wavelength from one or more diode laser emitter or diode laser arrays is substantially maintained at a desired wavelength. FIG. 1 shows an embodiment of a laser system 10. As shown, the laser system or light system 10 may include one or more emitters configured to emit one or more outputs. In the illustrated embodiment, the laser system 10 comprises a diode laser array having emitters D₁ 12, D₂ 14, D₃ 16, D₄ 18, D₅ 20, Dₙ 22 each emitting an output to a grating device 28. Any number of emitters may be used in the present system. Further, any variety of laser systems or light emitting devices may be used to project one or more output beams to the grating device 28. Optionally, one or more additional optical elements 24 may be positioned proximate to the laser system 10, the grating device 28, or both. In the illustrated embodiment, the optical element 24 is positioned between the laser system 10 and the grating device 28, although those skilled in the art will appreciate that the optical element 24 may be positioned within the laser system 10, the grating device 28, or both. Exemplary additional optical elements 24 include, without limitation, beam combiners, polarizers, filters, spatial filters, lenses, and the like. In the illustrated embodiment the laser system 10 comprises multiple diode lasers D₁ 12-Dₙ 22. Optionally, the laser system 10 may comprise one or more fiber lasers, gas lasers, solid state lasers, disc lasers, surface emitting lasers, slab lasers, silicon lasers, and the like. In an alternate embodiment, the laser system 10 comprises light emitting diodes. In one embodiment, the laser system 10 comprises a variety of emitters.

Referring again to FIG. 1, each emitter may be separated from an adjoining emitter by a distance or pitch. FIG. 1 shows D₁ 12 and D₂ 14 separated by a pitch P₁. In the illustrated embodiment, the pitch is approximately 1.8 mm, although those skilled in the art will appreciate that the emitters may be separated by any pitch. Optionally, the pitch P₁ between adjoining emitters may be equal. In an alternate embodiment, the pitch P₁ between adjoining emitters may be varied.

As shown in FIG. 1, the grating device 28 comprises a device body 30 having one or more grating regions formed thereon. In the illustrated embodiment, the device body 30 includes grating regions R₁ 32, R₂ 34, R₃ 36, R₄ 38, R₅ 40, and Rₙ 42 formed thereon. IN one embodiment, the grating device 28 comprises a volume transmission grating. For example, in one embodiment the volume transmission grating comprises a volume Bragg grating. In one embodiment, the grating regions R₁ 32-R₁ 42 are holographically formed on the grating device 28 using techniques known in the art. Optionally, the grating regions R₁ 32-Rₙ 42 may be formed using any variety of techniques, including, without limitation, etching, chemical treatment, mechanically ruled, optically formed, and the like. Each grating region R₁ 32-Rₙ 42 receives an input from and provides a feedback to a single associated emitter D₁ 12-Dₙ 22. For example, grating region R₁ 32 receives an input from and provides feedback to emitter D₁ 12, thereby reducing or eliminating cross-talk between emitters while limiting the emitter output wavelength to a desired range. Like the emitter devices, the grating regions R₁ 32-Rₙ 42 are separated by a distance or pitch P₂. In one embodiment, the grating regions or pitch P₂ of the grating regions R₁ 32, R₂ 34, R₃ 36, R₄ 38, R₅ 40, Rₙ 42 is equal to the pitch P₁ separating the emitters D₁ 12-Dₙ 22, such that P₁=P₂. A shown in FIG. 1, each grating region R₁ 32-Rₙ 42 generates an optical feedback back to the associated emitters D₁ 12-Dₙ 22. For example, grating region R₁ 32 emits an optical feedback to emitter D₁ 12. As know in the art, the illustrated optical feedback architecture shown in FIG. 1 may be used to lock the output wavelength of the emitters D₁ 12-Dₙ 22.

During use, an operator may easily adjust the output O₁-Oₙ of each grating region R₁ 32-Rₙ 42 by repositioning the grating regions R₁ 32-Rₙ 42 of the grating device 28 relative to the emitters D₁ 12-Dₙ 22. For example, in one embodiment the grating regions R₁ 32-Rₙ 42 comprises periodically-chirped holographic volume transmission gratings configured to transmit a narrow wavelength of light therethrough. As such, the holographic volume transmission gratings may be configured to diffract light along the fast axis and/or the slow axis of the light emitted by the emitters D₁ 12-Dₙ 22.

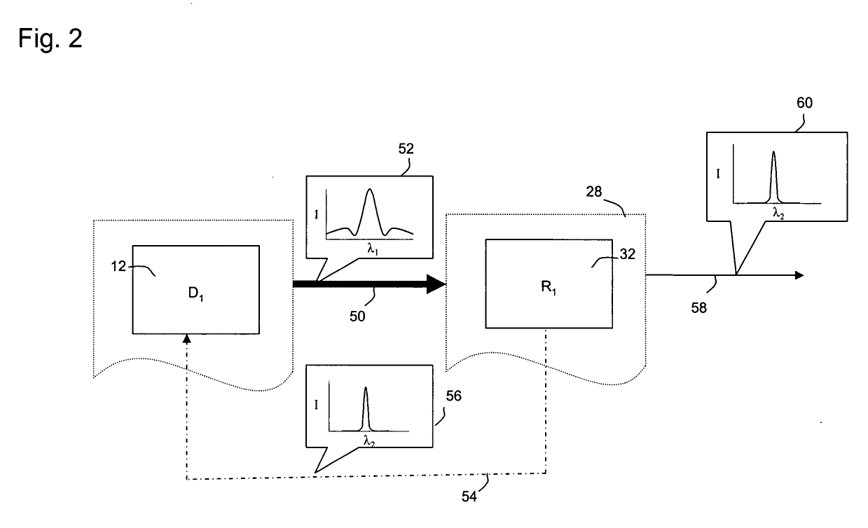

FIG. 2 shows a more detailed view of a single emitter-grating region interaction. It should be understood that the all emitters D₁ 12-Dₙ 22 and grating regions R₁ 32-Rₙ 42 interact in a similar manner. As shown, emitter D₁ 12 emits an output 50 having first wavelength spectrum 52. Thereafter, the output 50 is incident upon grating region R₁ 32 formed on the grating device 28. An optical feedback signal 54 is diffracted by grating region R₁ 32 to the emitter D₁ 12. As shown, the optical feedback signal 54 has a feedback wavelength spectrum 56 more narrow than that of the first wavelength spectrum 52. As a result, the first wavelength spectrum 52 of output 50 becomes more narrow in response to the optical feedback signal 54. In another embodiment, the grating device 28 may be configured to precisely tune the spectral peak of the second wavelength spectrum 60 using a similar feedback approach. In addition, the grating region R₁ 32 is configured to output light 58 having an output or second wavelength spectrum 60. As a result, the typically broad and variable first wavelength spectrum output 52 of the diode laser emitter 12 is narrowed to an second wavelength spectrum 60 having range of wavelength selected by the user.

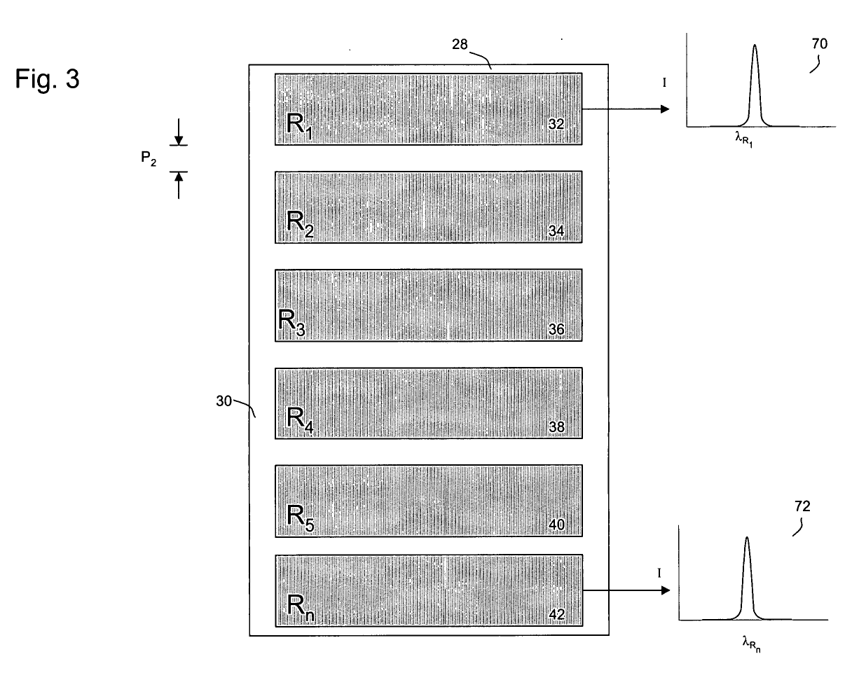

FIG. 3 shows an embodiment of a grating device 28. As shown, the grating device 28 includes a device body 30 having grating regions R₁ 32-Rₙ 42 formed thereon. In the illustrated embodiment, the grating regions R₁ 32-Rₙ 42 are configured to receive an input signal from one or more corresponding emitters D₁ 12-Dₙ 22 of a laser system 10 (See FIG. 1) and output substantially the same wavelength from each grating region R₁ 32-Rₙ 42. For example, each grating region comprises a periodically-chirped holographic volume transmission grating configured to transmit a narrow wavelength of light therethrough. Optionally, the grating device 28 may be configured to precisely tune the spectral peak of the second wavelength spectrum 60. As shown, the wavelength of output 70 of grating region R₁ 32 is substantially the same as the wavelength of output 72 of grating region Rₙ 42. Further, as stated above, the pitch P₂ between each grating region R₁ 32-Rₙ 42 is equal to the pitch between the emitters D₁ 12-Dₙ 22.

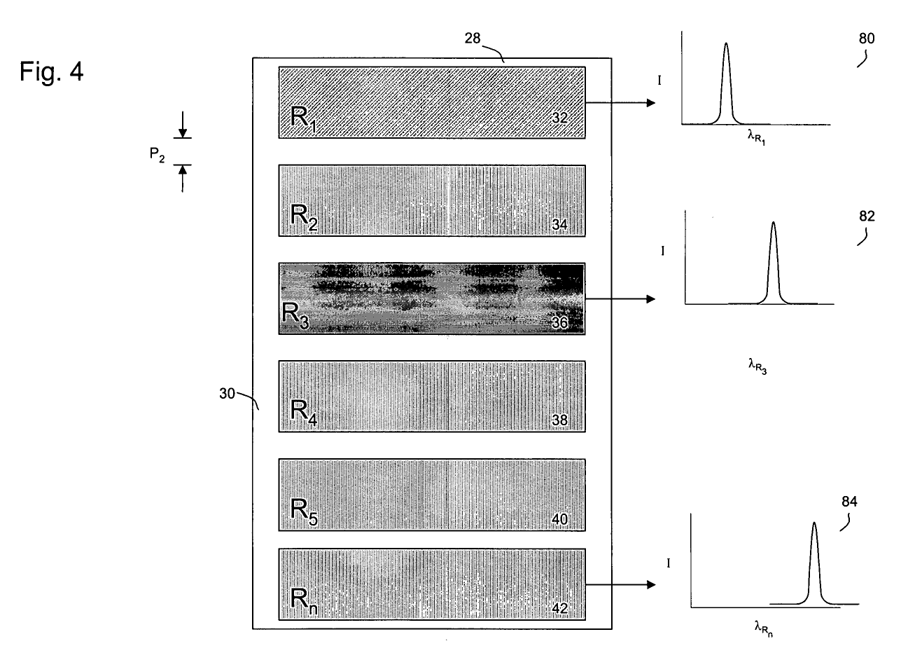

FIG. 4 shows another embodiment of a grating device 28. As shown, the grating regions R₁ 32-Rₙ 42 are configured to receive an input signal from one or more corresponding emitters D₁ 12-Dₙ 22 of a laser system 10 (See FIG. 1) and output different wavelengths from each grating region R₁ 32-Rₙ 42. For example, each grating region comprises a periodically-chirped holographic volume transmission grating configured to transmit a vary narrow wavelength of light therethrough. As shown, the wavelength of output 80 of grating region R₁ 32, the wavelength of output 82 of grating region R₃ 36, and the wavelength of output 84 of grating region Rₙ 42 are substantially different from one another. As such, the wavelength of the outputs of grating regions R₁ 32-Rₙ 42 may be substantially the same or, in the alternative, the output wavelength from at least two grating regions R₁ 32-Rₙ may be different. Further, as stated above, the pitch P₂ between each grating region R₁ 32-Rₙ 42 is equal to the pitch between the emitters D₁ 12-Dₙ 22.

Referring again to FIG. 1, during use the grating device 28 is positioned proximate to the laser system 10 such that the outputs of each individual emitter D₁ 12-Dₙ 22 are incident upon a single grating region R₁ 32-Rₙ 42. As shown, the pitch P₂ of the grating regions R₁ 32, R₂ 34, R₃ 36, R₄ 38, R₅ 40, Rₙ 42 is equal to the pitch P₁ separating the emitters D₁ 12-Dₙ 22, such that P₁=P₂. As a result, any movement of the grating device 28 relative to the laser system 10 would result in a uniform variation in the outputs of grating regions R₁ 32-Rₙ 42. Once positioned, the user may easily fine tune the output of the system by adjusting the position of a single optical element (the grating device 28) relative to the laser system 10, in contrast to prior art systems which required the user to manually adjust each individual grating region relative to its associated emitter.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

1. A laser device, comprising:
at least one laser system having at least two emitters therein, each emitter configured to output a laser output having a first wavelength spectrum; and
at least one grating device having at least two grating regions formed thereon, each grating region configured to receive the laser output from one of the emitters and provide an optical feedback signal thereto, each grating region configured to output an output signal having at least a second wavelength spectrum.

2. The device of claim 1 wherein the laser system comprises a diode laser array having multiple laser emitters therein.

3. The device of claim 2 wherein the diode laser array include between two and five hundred emitters.

4. The device of claim 1 wherein the grating regions comprises a holographic volume transmission gratings.

5. The device of claim 1 wherein the second wavelength spectrum of the output signal is more narrow than the first wavelength spectrum of the laser output.

6. The device of claim 1 wherein each grating region is configured to provide an output signal having the second wavelength spectrum.

7. The device of claim 1 wherein at least one grating region is configured to provide an output signal having an output wavelength spectrum different from the second wavelength spectrum.

8. The device of claim 1 wherein each emitter is separated by a distance P1 and each grating region is separated by a distance P2, and distance P1 is equal to the distance P2.

9. The device of claim 1 wherein the distance P2 is about 0.5 mm to about 2.5 mm.

10. The device of claim 1 wherein the distance P2 is about 1.8 mm.

11. A periodically-chirped holographic volume transmission grating, comprising a device body having multiple grating regions formed thereon, each grating region separated from adjoining grating regions by a distance P2 and configured to receive a laser signal from and provide optical feedback to a single laser emitter included within a multiple emitter laser device, each grating region configured to output an output signal have a at least one output wavelength spectrum.

12. The device of claim 11 wherein the distance P2 separating the grating regions is equal to the distance separating the emitters of the laser device.

13. The device of claim 11 wherein the output wavelength spectrum is more narrow than a wavelength spectrum of the laser signal.

14. The device of claim 11 wherein each grating region is configured to output the same output wavelength spectrum.

15. The device of claim 11 wherein at least one grating region is configured to output a different output wavelength spectrum than surrounding grating regions.

16. A method of altering the wavelength spectrum of an output of a laser system, comprising:
forming multiple grating regions on a grating device, each grating region separated by a distance substantially equal to the distance individual emitters of a laser system, each grating region configured to alter a wavelength spectrum of each laser signal received from each emitter; and
adjusting the position of the grating device relative to the position of the emitters of the laser system to alter the wavelength spectrum of an output of the laser system.

17. The method of claim 16 wherein the adjustment to the position of the grating device relative to the emitters of the laser system results in a narrowing of the wavelength spectrum of the laser system.

18. The method of claim 16 wherein the adjustment to the position of the grating device relative to the emitters of the laser system results in varying the a spectral peak of the wavelength spectrum of the laser system.

19. A method of manufacturing a periodically-chirped holographic volume transmission grating, comprising:
providing a grating body; and
holographically forming multiple grating regions on the grating body, each grating region separated from adjoining grating region by a distance of about 0.5 mm to about 2.5 mm.
